(19) United States
(12) Patent Application Publication
(10) Pub. No.: US 2009/0144480 A1
(43) Pub. Date: Jun. 4, 2009

(54) MULTI-PROCESSOR SYSTEM ON CHIP PLATFORM AND DVB-T BASEBAND RECEIVER USING THE SAME

(76) Inventors: JUN-DONG CHO, Seongnam-si (KR); Koon Shik, Seoul (KR); Seung Hoon Lee, Seoul (KR); Jong Chul Kim, Seoul (KR); Byung Joo Hong, chungcheongbuk-do (KR); Suk Yun Lee, Anyang-si (KR)

Correspondence Address: LEXYOUME IP GROUP, LLC, 5180 PARKSTONE DRIVE, SUITE 175, CHANTILLY, VA, 20151, US

(21) Appl. No.: 11/949,716

(22) Filed: Dec. 3, 2007

(51) Int. Cl. G06F 13/00

(52) U.S. Cl. 710/317

(57) ABSTRACT

A multi-processor system on chip (SoC) platform and a DVB-T baseband receiver using the same are disclosed. The multi-processor SoC platform includes a first processor, at least one second processor, at least one slave device communicating with the first processor and the second processor and a communication interface (CI) unit connecting the slave device to the first processor and the second processor according to a cross-bar switching method to allow the slave device to be communicated with the first processor and the second processor. Therefore, the multi-processor SoC platform having flexibility with being adapted for high speed calculation by using a cross-bar switch is provided.

### BACKGROUND OF THE INVENTION

1. Field of the Invention

The present invention relates to a multi-processor system on chip (SoC) platform and a DVB-T baseband receiver using the same; and, more particularly, to a multi-processor SoC platform having a flexibility with being adapted for high speed calculation by using a cross-bar switch and a DVB-T baseband receiver using the same.

2. Background of the Related Art

Generally, an embedded system occupying the portion of rapidly increasing IT market in future has the form of a sub system to be inserted for back-end processing a specific function given in a large-scale system. Such embedded system requires both a software element and a hardware element at the same time and is manufactured in a shape of a system on chip (SoC).

Herein, the development of the SoC is difficult for performing a simulation by modeling a target system as well as has a bad environment for debugging and requires a simultaneous work between the hardware and the software since a time-to-market (TTM) is short.

Therefore, it is difficult for maximizing the performance with minimizing a size of chip and overcoming the productivity problem of design by using a conventional cell based design method through an optimization of the gate level. In order to overcome such problems, a platform based design on the basis of an intellectual property (IP) reuse has been proposed as a new SoC design method.

Herein, in a virtual socket interface alliance (VSIA), the platform is defined as a hardware and software IP block or model and a design tool which is formalized and unified in advance.

Specifically, since a multi-tasking environment is general and the appearance of new standards and the extensions of conventional standards have frequently occurred in case of a multi-media application, the SoC design based on the software becomes more important.

The digital signal processing requires more complex calculations and high speed data processes and a target system to match with this is required to effectively perform the high speed data processes and the plurality of complex calculations at the same time. And also, the use of a heterogeneous multi-processor has been increased to satisfy the performance required for the digital signal processing system.

FIG. 1 is a diagram showing a conventional dual processor platform based on an advanced microcontroller bus architecture advanced high-performance bus (AMBA AHB).

In the dual processor platform as shown in FIG. 1, an advanced RISC machines (ARM) processor and a digital signal processing (DSP) processor are used as a processor as an example. Also, ARM926ejs is used as the ARM processor and Teak is used as the DSP processor.

And, a slave device includes a shared memory, a plurality of intellectual property (IP) blocks, a direct memory access (DMA) or the like are constituted as a slave device.

However, in the conventional dual processor platform, as shown in FIG. 1, the AMBA AHB having a Mux structure is used as a bus, there is a shortcoming that, if a processor as one master accesses only one slave device, the other master is impossible to access the other slave devices which are not accessed due to the limitation of the AMBA AHB itself. This acts as the deterioration cause of overall process speed by being directly connected to the process speed of the processor.

### SUMMARY OF THE INVENTION

### Technical Problem

It is, therefore, an object of the present invention to provide a multi-processor system on chip (SoC) platform having a flexibility with being adapted for high speed calculation by using a cross-bar switch and an apparatus for receiving a DVB-T baseband using the same.

### Technical Solution

In accordance with an aspect of the present invention, there is provided a multi-processor system on chip (SoC) platform, including a first processor, at least one second processor, at least one slave device communicating with the first processor and the second processor and a communication interface (CI) unit connecting the slave device to the first processor and the second processor according to a cross-bar switching method to allow the slave device to be communicated with the first processor and the second processor.

And, the CI unit includes a cross-bar switch comprising a plurality of cross-bar cells forming a communication channel between the first processor and the second processor and the slave device according to the cross-bar switching method and a CI controller for controlling the cross-bar switch to form the communication channel to the slave device in response to an access request when the access request from at least one of the first processor and the second processor to the slave device exists.

And also, the CI controller determines an access order to the slave device according to a predetermined priority policy when the access request from at least two of the first processor and the second processor to a particular slave device among the salve devices exists.

And also, the CI controller determines the access order to the particular slave device according to a Round Robin priority policy.

And also, the number of the unit cross-bar cells is n×m when the total number of the first processor and the second processor is n and the total number of the slave devices is m.

And also, the first processor includes a main processor managing an overall schedule and be in charge of communicating with external devices and the second processor includes a digital signal processing(DSP) processor processing a digital signal.

And also, the main processor includes an advanced RISC machines (ARM) processor.

And also, the main processor manages the schedule according to European norm (EN) 300 744 standard of European telecommunications standard institute (ETSI).

And also, the slave device includes at least one shared memory and at least one intellectual property (IP) block.

In accordance with another aspect of the present invention, there is provided a DVB-T baseband receiver, including a main processor managing an overall schedule and being in charge of communicating with external devices, at least one digital signal processing (DSP) processor processing a digital signal, at least one slave device communicating with the main processor and the DSP processor and a communication interface (CI) unit connecting the slave device to the main processor and the DSP processor according to a cross-bar switching method to allow the slave device to communicate with the main processor and the DSP processor.

And, the CI unit includes a cross-bar switch comprising a plurality of unit cross-bar cells forming communication channels between the main processor and the DSP processors and the slave devices according to the cross-bar switching method and a CI controller for controlling the cross-bar switch to form a communication channel to the slave device when the access request from at least one of the main processor and the DSP processor to the slave device exists.

And also, the CI controller determines an access order to the slave device according to a predetermined priority policy when the access request from at least two of the main processor and the DSP processor to a particular slave device among the slave devices exists.

And also, the CI controller determines the access order to the particular slave device according to a Round Robin priority policy.

And also, the number of the unit cross-bar cells is n×m when the total number of the main processor and the DSP processor is n and the total number of the slave devices is m.

And also, the main processor includes an advanced RISC machines (ARM) processor.

And also, the main processor manages the schedule according to European norm (EN) 300 744 standard of European telecommunications standard institute (ETSI).

And also, the slave device includes at least one shared memory and at least one intellectual property (IP) block.

### Effect of the Invention

As described above, in accordance with the present invention, a multi-processor SoC platform having a flexibility with being adapted for high speed calculation by using a cross-bar switch and a DVB-T baseband receiver using the same are provided.

### BRIEF DESCRIPTION OF THE DRAWINGS

FIG. 1 is a diagram showing a conventional dual processor platform based on an advanced microcontroller bus architecture advanced high-performance bus (AMBA AHB);

FIG. 2 to FIG. 4 are diagrams representing a construction of a multi-processor system on chip (SoC) platform according to the present invention;

FIG. 5 is a diagram depicting one embodiment of a unit cross-bar cell of the multi-processor system SoC platform according to the present invention;

FIG. 6 is a diagram illustrating an operation of a cell part of the unit cross-bar cell shown in FIG. 5;

FIG. 7 and FIG. 8 are state diagrams of a CI controller according to a Round Robin priority policy;

FIG. 9 is a diagram representing a scheduling of an algorithm during the synchronization when the power is applied to a DVB-T baseband receiver according to the present invention; and

FIG. 10 is a diagram showing a scheduling after the date of the scheduling shown in FIG. 9.

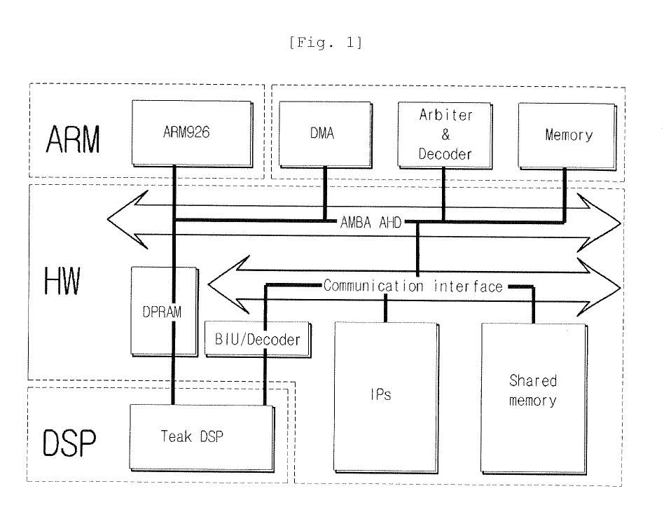

### DETAILED DESCRIPTION OF THE INVENTION

Hereinafter, a preferred embodiment of the present invention will be described in detail with reference to the accompanying drawings. Herein, in explaining the present invention, an embodiment that a system on chip (SoC) platform in accordance with the present invention is applied to a DVB-T baseband receiver is described as one example.

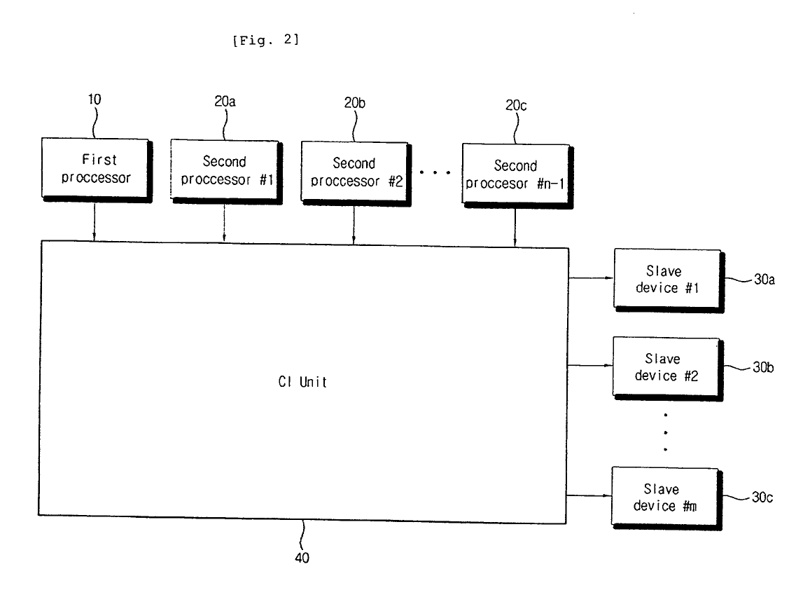

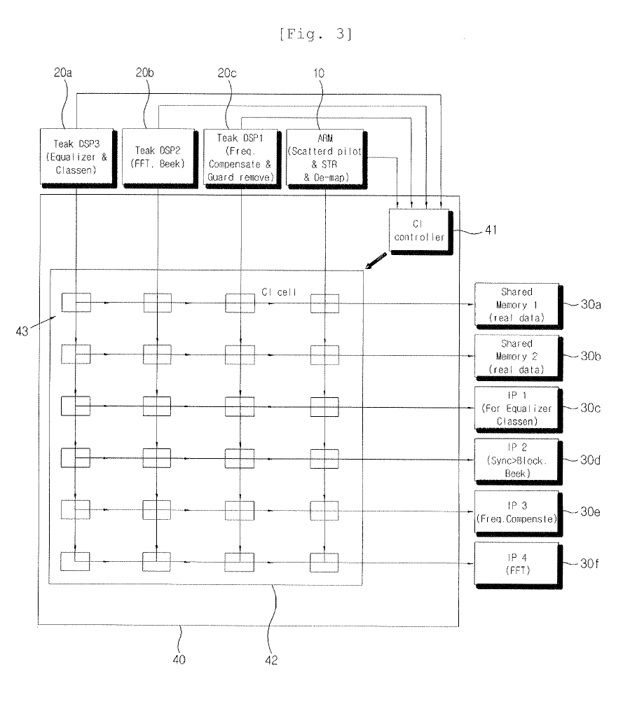

As shown in FIG. 2 and FIG. 3, the multi-processor SoC platform according to the present invention includes a first processor 10, at least one second processor 20a, 20b and 20c, a plurality of slave devices 30a, 30b, 30c, 30d, 30e and 30f and a communication interface (CI) unit 40.

The first processor 10 may manage an overall schedule of the multi-processor SoC platform according to the present invention and includes a main processor to be in charge of communicating with external devices. In the multi-processor SoC platform according to the present invention, an advanced RISC machine (ARM) processor is used as a main processor as an example.

And, for example, the main processor according to the present invention manages the scheduling according to European norm (EN) 300 744 standard of European telecommunications standard institute (ETSI).

The second processors 20a, 20b and 20c may include a digital signal processing (DSP) processor which is capable of processing a digital signal.

The first processor 10 and the plurality of second processors 20a, 20b and 20c access the plurality of slave devices 30a, 30b, 30c, 30d, 30e and 30f through the CI unit 40. Herein, the plurality of slave devices 30a, 30b, 30c, 30d, 30e and 30f according to the present invention may include at least one shared memory and at least one intellectual property (IP) block.

Herein, as shown in FIG. 3, the IP block may include a block such as a fast Furier transform (FFT) block, a frequency compensate block, a fine frequency synchronization block using a Beek algorithm, a coarse frequency synchronization block using a Classen algorithm or the like.

The CI unit 40 connect the first processor 10 and the second processors 20a, 20b and 20c to the slave devices 30a, 30b, 30c, 30d, 30e and 30f to communicate therebetween, and the CI unit 40 according to the present invention connects the first processor 10 and the second processors 20a, 20b and 20c to the slave devices 30a, 30b, 30c, 30d, 30e and 30f according to a cross-bar switching method.

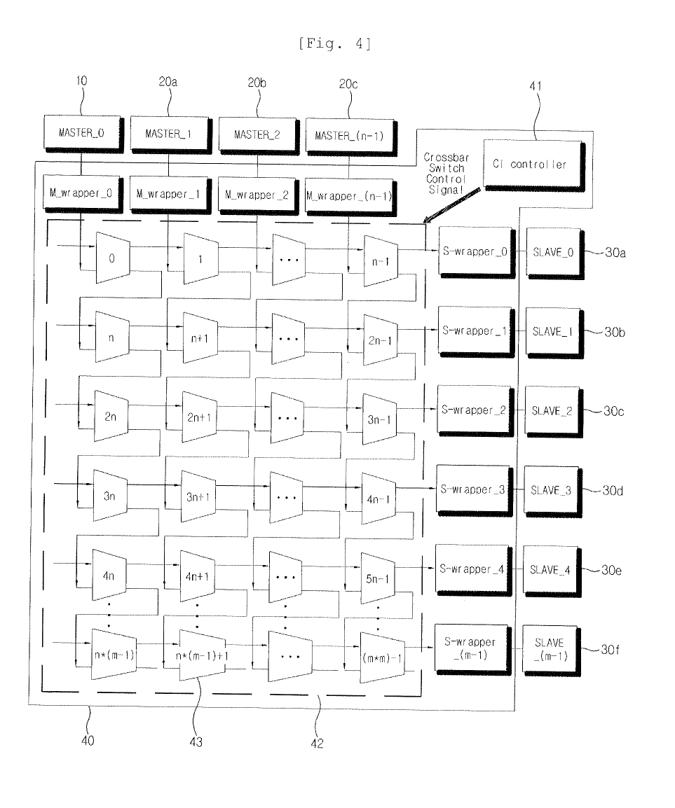

Referring to FIG. 3 and FIG. 4, the CI unit 40 may include a cross-bar switch 42 and a CI controller 41.

The cross-bar switch 42 comprises a plurality of unit cross-bar cells 43 to form a plurality of communication channels between the first processor 10 and the second processors 20a, 20b and 20c and the plurality of slave devices 30a, 30b, 30c, 30d, 30e and 30f according to the cross-bar switching method. Herein, as shown in FIG. 4, the number of the unit cross-bar cells 43 is prepared by n×m, when the total number of masters constructed by the first processor 10 and the second processors 20a, 20b and 20c is n and the total number of the slave devices 30a, 30b, 30c, 30d, 30e and 30f is m.

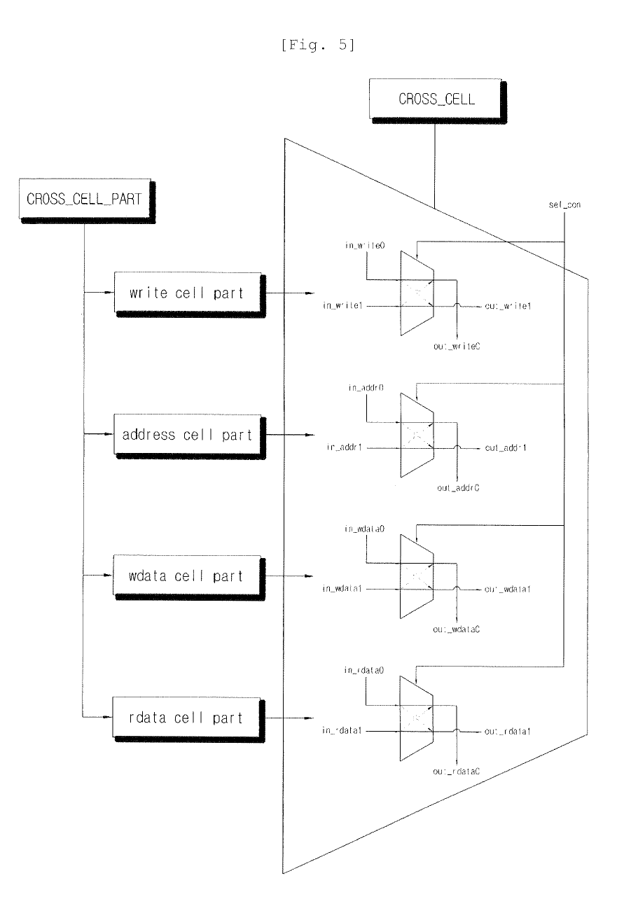

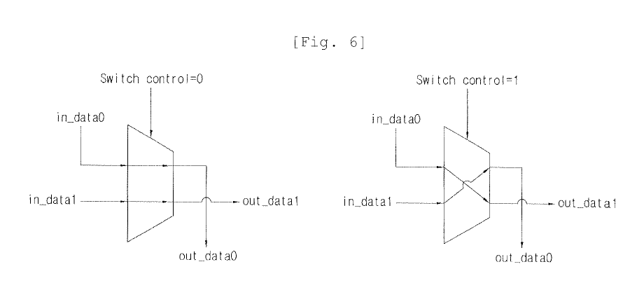

FIG. 5 is a diagram depicting a structure of the unit cross-bar cell 43 according to the present invention. As shown in FIG. 5, the unit cross-bar cell 43 may comprise a wdata cell part, a rdata cell part, a write cell part and an address cell part. As shown in FIG. 6, each of the cell parts has two inputs and two outputs, is connected to the unit cross-bar cell 43 which is arranged in the lower part in FIG. 5 when a switch control signal (sel_con of FIG. 5, hereinafter the same) is 0 and is connected to the unit cross-bar cell 43 which is arranged in the right side in FIG. 5 when the switch control signal is 1.

Unless the first processor 10 or the second processors 20a, 20b and 20c as a master access a particular slave device (for example, the slave device 30a) among the slave devices 30a, 30b, 30c, 30d, 30e and 30f at the same time, each of the masters connects the slave devices 30a, 30b, 30c, 30d, 30e and 30f, respectively, using an individual bus formed by the above described cross-bar switching method and prevents a bottleneck phenomenon of a bus due to one master from being generated.

On the other hand, when an access request from any one among the first processor 10 and the second processors 20a, 20b and 20c to the slave devices 30a, 30b, 30c, 30d, 30e and 30f exists, the CI controller 41 controls the cross-bar switch 42 to form the communication channel to the corresponding slave devices 30a, 30b, 30c, 30d, 30e and 30f in response to the access request.

And also, when access requests from at least two among the first processor 10 and the second processors 20a, 20b and 20c to the particular slave device among the slave devices 30a, 30b, 30c, 30d, 30e and 30f exist at the same time, the CI controller 41 performs arbitration function to redistribute the right of possession for the slave devices 30a, 30b, 30c, 30d, 30e and 30f of the first processor 10 and the second processors 20a, 20b and 20c as a master to the master by determining an access order to the slave devices 30a, 30b, 30c, 30d, 30e and 30f according to a predetermined priority policy.

Herein, the CI controller 41 may determine an access order to the particular slave device 30a, 30b, 30c, 30d, 30e or 30f according to a Round Robin priority policy when access requests from at least two among the first processor 10 and the second processors 20a, 20b and 20c to the particular slave device 30a, 30b, 30c, 30d, 30e or 30f exist at the same time.

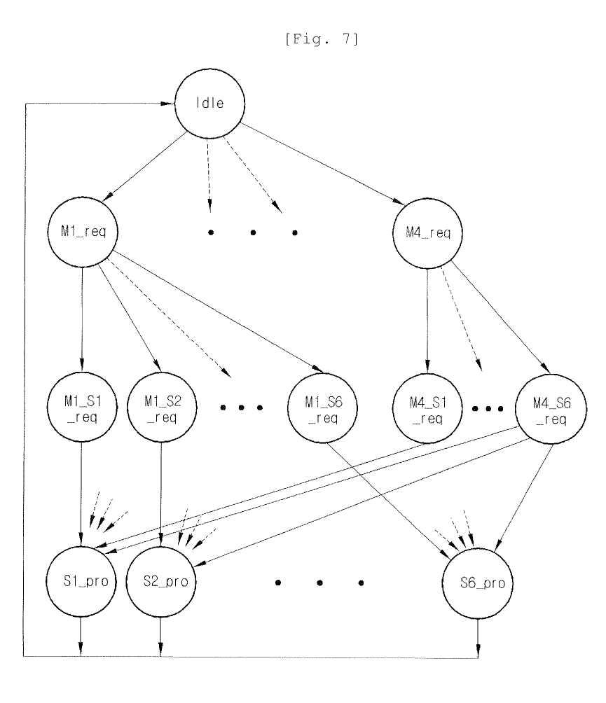

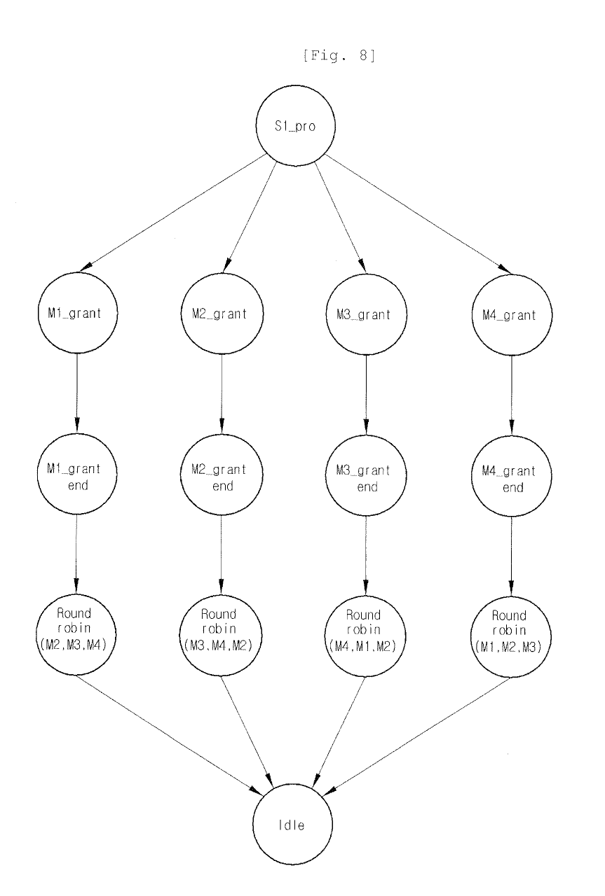

FIG. 7 and FIG. 8 are state diagrams of the CI controller 41 according to the Round Robin priority policy. Herein, a case that four masters (one first processor 10 and three second processors 20a, 20b and 20c) and six slave devices 30a, 30b, 30c, 30d, 30e and 30f are connected to the cross-bar switch 42 is described hereinafter as an example.

Idle State

Idle state is a initialization state of the CI controller. In case when the multi-processor SoC platform according to the present invention is applied to a DVB-T baseband receiver, the CI controller 41 exists at the Idle state when power is applied to the DVB-T baseband receiver or after performing the reset. In the Idle state, the CI controller 41 always receives and processes the access request to the slave devices 30a, 30b, 30c, 30d, 30e and 30f (shared memories and IP blocks) from the first processor 10 or the second processors 20a, 20b and 20c as a master.

M1 Req. State (Master 1 Request State)

M1_req state is a state that a master 1 transmits an access request to the CI controller 41. The master 1 informs the CI controller 41 of the slave devices 30a, 30b, 30c, 30d, 30e and 30f to be accessed by transmitting ID of the corresponding slave devices 30a, 30b, 30c, 30d, 30e and 30f to the CI controller 41. Herein, the CI controller 41 is shifted to a state such as M1_S1_req, M2_req, M3_req and M4_req by determining the ID of the slave devices 30a, 30b, 30c, 30d, 30e and 30f. The M2_req, M3_req and M4_req states are also processed similar to the M1_req state.

S1 Pro State (Slave1 Process)

S1_pro state is a state that each of the masters requests an access to the slave device 30a, 30b, 30c, 30d, 30e and 30f ‘1’. For example, when only master 1 requests an access to the slave device 30a, 30b, 30c, 30d, 30e or 30f ‘1’, it is shifted to the M1_grant state (master 1 access admission) However, when the plurality of masters request accesses for the slave device 30a, 30b, 30c, 30d, 30e or 30f ‘1’, the access admission is permitted based on the priority order for the master, that is, the priority order according to the above-described Round Robin priority policy. And also, the shifts of the remaining S2_pro, S3_pro, S4_pro, S5_pro and S6_pro states are similar to that of the S1_pro state, thereby omitting the description thereof. M1_grant state, M1_gran_end state and Round Robin state are dependent on the S1_pro state to be described hereinafter.

M1 Grant State (Master1 Grant)

M1_grant state is a state that an access of a master 1 is admitted for the slave device 30a, 30b, 30c, 30d, 30e or 30f ‘1’. In the M1_grant state, it is informed by transmitting a grant signal to a corresponding master. And, a communication channel is formed by allowing the CI controller 41 to control the cross-bar switch 42 so as to connect the slave device 30a, 30b, 30c, 30d, 30e or 30f ‘1’ to the master 1.

M1 Grant End State (Master1 Grant End)

M1_grant_end state is a state that an access of the master 1 for the slave device 30a, 30b, 30c, 30d, 30e or 30f ‘1’ is finished. The grant signal for the slave device 30a, 30b, 30c, 30d, 30e or 30f ‘1’ is changed into a non-active state by receiving an access end signal for the slave device 30a, 30b, 30c, 30d, 30e or 30f ‘1’ from the master 1 and the M1_grant_end state is shifted to a next state.

Round Robin State

If another master access request for the slave devices 30a, 30b, 30c, 30d, 30e and 30f 1 does not exist in the Round Robin state, the Round Robin state is shifted to the Idle state. If the other master access request is standby, an access admission for the slave device 30a, 30b, 30c, 30d, 30e or 30f ‘1’ is permitted to the next master according to a Round Robin priority policy. That is, a continuous access obtained by having a priority order for only one master is prevented through the Round Robin priority policy. For example, if the access of the master 1 is finished in the state that the access of the master 1 is admitted and the masters 2, 3 and 4 are on standby, the access of the master 2 is permitted. At this time, in case when the master 1 requests an access for the slave device 30a, 30b, 30c, 30d, 30e or 30f ‘1’ again, the order of the masters on standby according to the Round Robin priority policy is the master 3, the master 4 and the master 1. If the request of the master for accessing the slave device 30a, 30b, 30c, 30d, 30e and 30f ‘1’ does not exist, the Round Robin state is shifted to the Idle state.

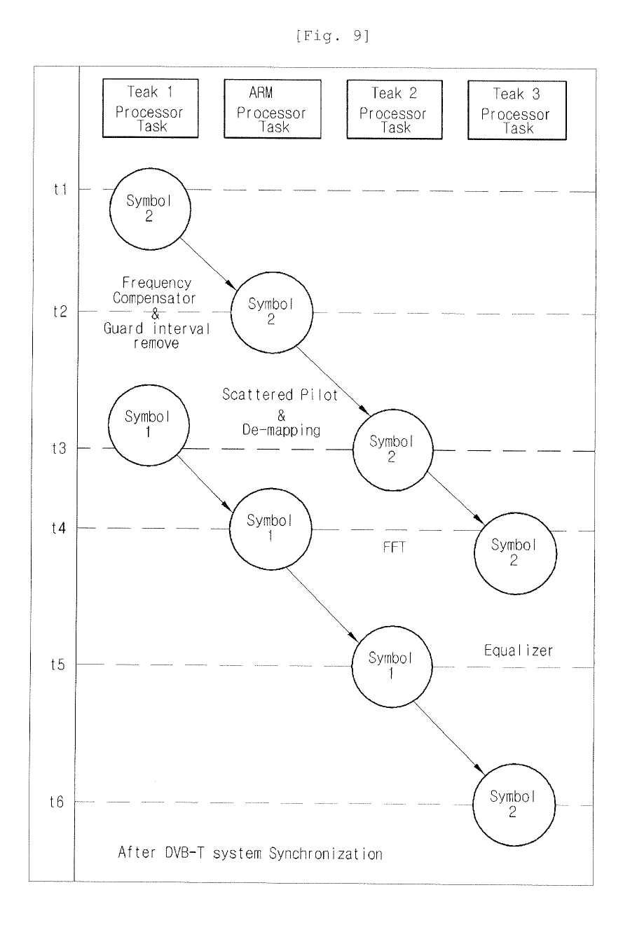

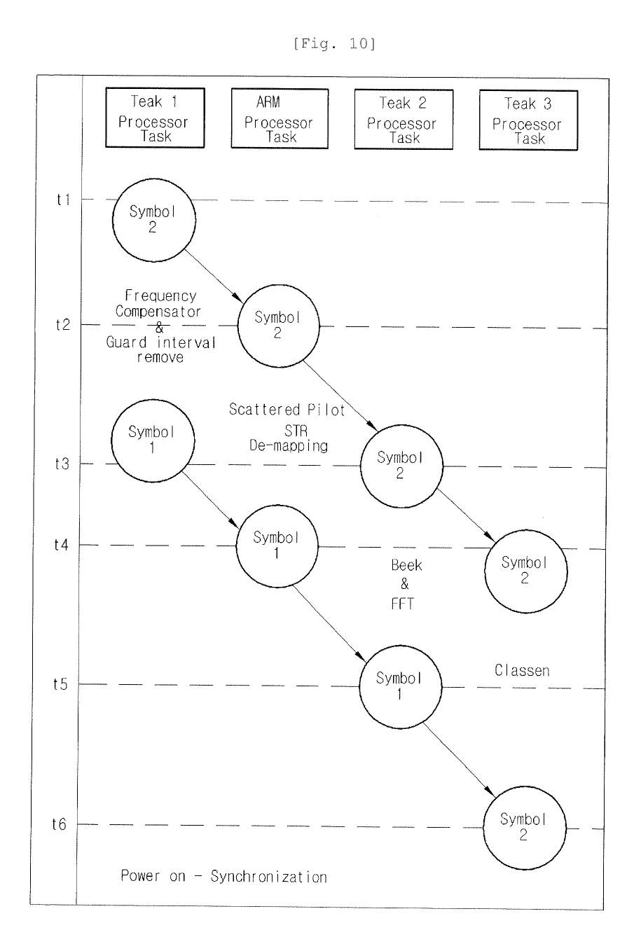

Meanwhile, FIG. 9 is a diagram representing a scheduling of an algorithm during the synchronization when the power is applied to a DVB-T baseband receiver in accordance with the present invention; and FIG. 10 is a diagram representing a scheduling after FIG. 9.

As shown in FIGS. 9 and 10, each block of the DVB-T baseband receiver as described above is scheduled so as to satisfy European norm (EN) 300 744 standard of European telecommunications standard institute (ETSI), this means that an whole symbol period is 252 μs for the case of 2 k mode and Guard interval being ⅛ in the 8 MHz channel, wholly forms a pipeline structure, a detailed algorithm is performed in parallel between each if the second processors 20a, 20b and 20c, that is, between each of the digital signal processing (DSP) processors.

While the present invention has been described with respect to certain preferred embodiments, it will be apparent to those skilled in the art that various changes and modifications may be made without departing from the scope of the invention as defined in the following claims.

What is claimed is:

1. A multi-processor system on chip (SoC) platform, comprising:
a first processor;
at least one second processor;
at least one slave device communicating with the first processor and the second processor; and
a communication interface (CI) unit connecting the slave device to the first processor and the second processor according to a cross-bar switching method to allow the slave device to be communicated with the first processor and the second processor.

2. The multi-processor SoC platform according to claim 1, wherein the CI unit includes:
a cross-bar switch comprising a plurality of cross-bar cells forming a communication channel between the first processor and the second processor and the slave device according to the cross-bar switching method; and
a CI controller for controlling the cross-bar switch to form the communication channel to the slave device in response to an access request when the access request from at least one of the first processor and the second processor to the slave device exists.

3. The multi-processor SoC platform according to claim 2, wherein the CI controller determines an access order to the slave device according to a predetermined priority policy when the access request from at least two of the first processor and the second processor to a particular slave device among the salve devices exists.

4. The multi-processor SoC platform according to claim 3, wherein the CI controller determines the access order to the particular slave device according to a Round Robin priority policy.

5. The multi-processor SoC platform according to claim 3, wherein the number of the unit cross-bar cells is n×m when the total number of the first processor and the second processor is n and the total number of the slave devices is m.

6. The multi-processor SoC platform according to claim 1, wherein the first processor includes a main processor managing an overall schedule and be in charge of communicating with external devices and the second processor includes a digital signal processing (DSP) processor processing a digital signal.

7. The multi-processor SoC platform according to claim 6, wherein the main processor includes an advanced RISC machines (ARM) processor.

8. The multi-processor SoC platform according to claim 6, wherein the main processor manages the schedule according to European norm (EN) 300 744 standard of European telecommunications standard institute (ETSI).

9. The multi-processor SoC platform according to claim 6, wherein the slave device includes at least one shared memory and at least one intellectual property (IP) block.

10. A DVB-T baseband receiver, comprising:
a main processor managing an overall schedule and being in charge of communicating with external devices;
at least one digital signal processing (DSP) processor processing a digital signal;
at least one slave device communicating with the main processor and the DSP processor; and
a communication interface (CI) unit connecting the slave device to the main processor and the DSP processor according to a cross-bar switching method to allow the slave device to communicate with the main processor and the DSP processor.

11. The DVB-T baseband receiver according to claim 10, wherein the CI unit includes:
a cross-bar switch comprising a plurality of unit cross-bar cells forming communication channels between the main processor and the DSP processors and the slave devices according to the cross-bar switching method; and
a CI controller for controlling the cross-bar switch to form a communication channel to the slave device when the access request from at least one of the main processor and the DSP processor to the slave device exists.

12. The apparatus for receiving the DVB-T baseband according to claim 11, wherein the CI controller determines an access order to the slave device according to a predetermined priority policy when the access request from at least two of the main processor and the DSP processor to a particular slave device among the slave devices exists.

13. The apparatus for receiving the DVB-T baseband according to claim 12, wherein the CI controller determines the access order to the particular slave device according to a Round Robin priority policy.

14. The apparatus for receiving the DVB-T baseband according to claim 12, wherein the number of the unit cross-bar cells is n×m when the total number of the main processor and the DSP processor is n and the total number of the slave devices is m.

15. The apparatus for receiving the DVB-T baseband according to claim 10, wherein the main processor includes an advanced RISC machines (ARM) processor.

16. The apparatus for receiving the DVB-T baseband according to claim 15, wherein the main processor manages the schedule according to European norm (EN) 300 744 standard of European telecommunications standard institute (ETSI).

17. The apparatus for receiving the DVB-T baseband according to claim 15, wherein the slave device includes at least one shared memory and at least one intellectual property (IP) block.
